(19) United States
(12) Patent Application Publication
(10) Pub. No.: US 2014/0372927 A1
(43) Pub. Date: Dec. 18, 2014

(54) Providing Visualization of System Architecture

(71) Applicants: Cedric Hebert, Mougins (FR); Wihem Arsac, Biot (FR); Gilles Montagnon, Mougins (FR); Jakub Sendor, Nice (FR); Elton Mathias, Nice (FR)

(72) Inventors: Cedric Hebert, Mougins (FR); Wihem Arsac, Biot (FR); Gilles Montagnon, Mougins (FR); Jakub Sendor, Nice (FR); Elton Mathias, Nice (FR)

(21) Appl. No.: 13/918,101

(22) Filed: Jun. 14, 2013

(51) Int. Cl. G06F 3/0484

(52) U.S. Cl. CPC G06F 3/0484
USPC 715/771

(57) ABSTRACT

Techniques for managing a display of a system architecture include displaying a first visual representation of the system architecture that includes respective virtual representations of at least two components of the system architecture at a first level of detail; displaying a first virtual representation of a semantically relevant connector that extends between the two components of the system architecture at the first level of detail; receiving a request from a user to display a second visual representation of the system architecture; and generating a second visual representation of the system architecture for display, that includes respective virtual representations of the at least two components of the system architecture at a second level of detail different than the first level of detail, and a second virtual representation of the semantically relevant connector that extends between the at least two components of the system architecture at the second level of detail.

### TECHNICAL FIELD

The present disclosure relates to software, computer systems, and computer implemented methods for interactive visualization of system architecture.

### BACKGROUND

Information technology (IT) system architecture represent sets of systems grouped by any number of properties with an arbitrary number of relations between each other. The structure and content of the system architecture renders them large and complex. In some examples, one or more systems can consist of several sub-systems Each sub-system can also represent an architecture and have relations to other systems or subsystems. Some examples of modern IT system architecture are the emerging cloud infrastructure and the legacy infrastructure of major software companies. For the enumerated examples and in other cases, the visualization of IT system architecture can be very important. However, the visualization of large and complex system architecture on a standard-sized computer screen can raise several difficulties.

### SUMMARY

The present disclosure relates to computer-implemented methods, computer-readable media, and computer systems for managing a display of a system architecture. One general implementation of a computer-implemented method includes displaying a first visual representation of the system architecture, the first visual representation including respective virtual representations of at least two components of the system architecture at a first level of detail; displaying a first virtual representation of a semantically relevant connector that extends between the at least two components of the system architecture at the first level of detail, the semantically relevant connector defining a functional interaction between the at least two components of the system architecture; receiving a request from a user to display a second visual representation of the system architecture; and generating a second visual representation of the system architecture for display on a graphical user interface, the second visual representation of the system architecture including respective virtual representations of the at least two components of the system architecture at a second level of detail different than the first level of detail, and a second virtual representation of the semantically relevant connector that extends between the at least two components of the system architecture at the second level of detail.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

A first aspect combinable with the general implementation includes changing from the first virtual representation of the semantically relevant connector to the second virtual representation of the semantically relevant connector based on the request to display the second visual representation of the system architecture.

In a second aspect combinable with any of the previous aspects, the first and the second virtual representations of the semantically relevant connector represent at least two functions that define the functional interaction between the at least two components of the system architecture.

In a third aspect combinable with any of the previous aspects, the first virtual representation includes unique symbols representing the at least two functions, and the second virtual representation includes a single symbol representing the at least two functions.

In a fourth aspect combinable with any of the previous aspects, the at least two functions include a read function and a write function, and one of the unique symbols represents the read function and another of the unique symbols represents the write function, and the single symbol represents a read/write function.

In a fifth aspect combinable with any of the previous aspects, the second virtual representation includes unique symbols representing the at least two functions, and the first virtual representation includes a single symbol representing the at least two functions.

A sixth aspect combinable with any of the previous aspects further includes determining that two of the at least two components are agents of another of the at least two components; and based on the request from the user to display the second visual representation of the system architecture, generating a visual representation of the other of the at least two components that encompasses at least a portion of the two of the at least two components.

In a seventh aspect combinable with any of the previous aspects, receiving a request from a user to display a second visual representation of the system architecture includes at least one of: receiving a zoom-in request from the user to display the second visual representation of the system architecture at a finer granularity relative to the first visual representation; or receiving a zoom-out request from the user to display the second visual representation of the system architecture at a coarser granularity relative to the first visual representation.

In an eighth aspect combinable with any of the previous aspects, receiving a request from a user to display a second visual representation of the system architecture includes at least one of receiving a pan request from the user to display the second visual representation of a distinct portion of the system architecture relative to the first visual representation.

In a ninth aspect combinable with any of the previous aspects, receiving a request from a user to display a second visual representation of the system architecture includes: receiving a resize request from the user to display a selected component of the system architecture at a different size in the second visual representation relative to the first visual representation.

A tenth aspect combinable with any of the previous aspects further includes determining a first plurality of coordinates for a virtual representation of a particular component of the at least two components of the system architecture at the first level of detail, the plurality of coordinates defining a location of the determined virtual representation in the first visual representation.

An eleventh aspect combinable with any of the previous aspects further includes based on the received request, determining a second plurality of coordinates different than the first plurality of coordinates for the virtual representation of the particular component of the at least two components of the system architecture at the second level of detail, the second plurality of coordinates defining a location of the determined virtual representation in the second visual representation.

A twelfth aspect combinable with any of the previous aspects further includes persisting the determined first plurality of coordinates in a database; and retrieving, based on the received request, the persisted first plurality of coordinates to determine the second plurality of coordinates.

In a thirteenth aspect combinable with any of the previous aspects, the request includes a resize request, the method further including: determining, based on the request, that the second plurality of coordinates defines a size of the particular component that meets a threshold size to be viewed in the second visual representation; and rendering the particular component at the second plurality of coordinates for viewing in the second visual representation.

A fourteenth aspect combinable with any of the previous aspects further includes prior to rendering the particular component at the second plurality of coordinates, determining that the particular component includes at least two agent components within the particular component; determining that a size of each of the agent components meets the threshold size to be viewed in the second visual representation; and rendering the agent components for viewing in the second visual representation within the particular component.

A fifteenth aspect combinable with any of the previous aspects further includes determining at least one semantically relevant connector that extends between the agent components at the second level of detail, the semantically relevant connectors defining functional interactions between the agent components.

A sixteenth aspect combinable with any of the previous aspects further includes rendering the at least one semantically relevant connector that extends between the agent components in the second visual representation.

In a seventeenth aspect combinable with any of the previous aspects, the first plurality of coordinates include Cartesian coordinates.

Various implementations of an interactive system architecture visualization described in this disclosure can include none, one, some, or all of the following features. For example, the interactive visualization of system architecture in a computer graphics context can provide optimal sectional or global display for the end user, by conserving the semantics. The system architecture can provide the user with a graphical representation of the relationships and interconnectivity of the systems and/or subsystems that are included in the architecture. The interactive system architecture visualization allows a user to graphically view and interact with system architectures of any size, including extremely large system architectures.

While generally described as computer implemented software embodied on tangible media that processes and transforms the respective data, some or all of the aspects can be computer implemented methods or further included in respective systems or other devices for performing this described functionality. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions. The details of these and other aspects and implementations of the present disclosure are set forth in the accompanying drawings and the description below. Other features, components, and advantages of the disclosure can be apparent from the description and drawings, and from the claims.

### DESCRIPTION OF DRAWINGS

FIG. 1 depicts an example high-level architecture in accordance with implementations of the present disclosure.

FIGS. 2A and 2B depict rendering examples in accordance with implementations of the present disclosure.

FIG. 3 depicts a nester example in accordance with implementations of the present disclosure.

FIGS. 4A and 4B depict example systems in accordance with implementations of the present disclosure.

FIG. 5 depicts an example flow-chart depicting an example method that can be executed in accordance with implementations of the present disclosure.

FIG. 6 depicts an example flow-chart depicting an example method that can be executed in accordance with implementations of the present disclosure.

FIG. 7 is a schematic illustration of example computer systems that can be used to execute implementations of the present disclosure.

### DETAILED DESCRIPTION

This disclosure generally describes software, computer-implemented methods, and systems relating to providing interactive system architecture visualization. Modern IT system architectures tend to be large, complex and interconnected through various sorts of relations and dependencies. System architectures can include software, hardware, or combined software and hardware sets of components. In some implementations, a system architecture can be defined in the context of an elementary part of an IT operation.

The present disclosure is directed, in part, to a translation of human perception to a graphical user interface metaphor for visualizing the system architecture. The visualization of the architecture can be based on human perceptions, where components increase in their visual detail when one focuses more on that component (e.g., when the component-view-distance decreases). In some implementations, the increase in visual detail of a component appears in parallel with a decrease in visual detail of other components, while conserving the semantics of the system architecture. In some implementations, the increase in visual detail of a component appears in parallel with a decrease in the number of displayed components. For example, the visualization of the system architecture can proportionally decrease the number of displayed components, until the increase component is displayed on the entire screen. The visualization of the system architecture can be designed to be compatible with a standard-sized computer screen by optimizing the size and the number of components in a readable display (e.g., each visual component has a readable size on-screen). The resize action can be based on the modification of the coordinates of the displayed system architecture with respect to the entire system architecture. In some implementations, the coordinates include Cartesian coordinates.

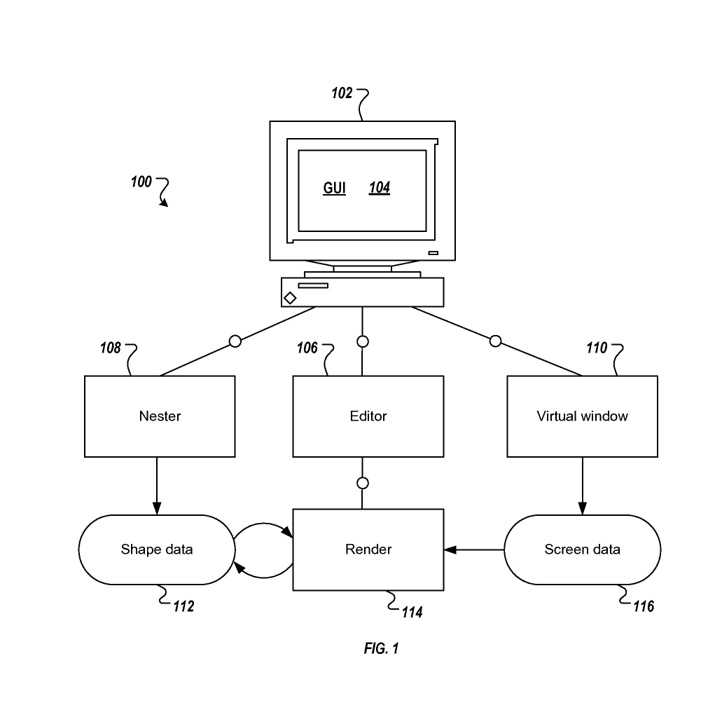

Turning to the example implementation of FIG. 1, the illustrated architecture 100 includes one or more clients 102, at least some of which visualize a representation of the system architecture. In general, architecture 100 depicts an example configuration capable of displaying a representation of system architecture on the interface 104. The display format of the system architecture is selected with the use of the editor 106 and other components, including a nester 108, a virtual window 110, shape data 112, a renderer 114, screen data 116 and a semantics module 118.

In general, each client 102 comprises an electronic computer device operable to receive, transmit, process, and store any appropriate data associated with the architecture 100 of FIG. 1. It can be understood that there can be any number of clients 102 associated with, or external to, architecture 100. For example, while illustrated architecture 100 includes one client, alternative implementations of the example architecture 100 can include multiple clients 102 communicably coupled to the interface 104.

Additionally, there can also be one or more additional clients 102 external to the illustrated portion of architecture 100 that are capable of interacting with the architecture 100 via a network. Further, the term “client” and “user” can be used interchangeably as appropriate without departing from the scope of this disclosure. Moreover, while each client 102 is described in terms of being used by a single user, this disclosure contemplates that many users can use one computer, or that one user can use multiple computers. As used in this disclosure, client 102 is intended to encompass a personal computer, touch screen terminal, workstation, network computer, kiosk, wireless data port, smart phone, personal data assistant (PDA), one or more processors within these or other devices, or any other suitable processing device. For example, each client 102 can comprise a computer that includes an input device, such as a keypad, touch screen, mouse, or other device that can accept user information, and an output device that conveys information associated with the operation performed by the client 102 itself, including digital data, visual information, the interface 104, the editor 106, the nester 108, the virtual window 110, shape data 112, the renderer 114 or screen data 116. Both the input and output device can include fixed or removable storage media such as a magnetic storage media, CD-ROM, or other suitable media to both receive input from and provide output to users of the client 102 through the display, namely, the interface 104.

In some implementations, client 102 is specifically associated with an administrator of the illustrated architecture 100. A client 102 (e.g., administrator) can modify various settings associated with one or more of the other clients 102, interface 104, the editor 106, and/or any relevant portion of architecture 100. For example, the client 102 can be able to modify the minimum size at which a component can be displayed on the interface 104.

Each client 102 can include a client application associated with the editor 106. In particular, the client application can be any software, such as a web browser or remote portion of the editor 106 that allows the client 102 to access and work with the interface 104. Particularly, the client application can be a software application that enables the client 102 (or a user thereof) to display and interact with the interface 104.

Further, the illustrated client 102 includes an interface 104 comprising a graphical user interface operable to interface with at least a portion of architecture 100 for any suitable purpose, including generating a visual representation of the system architecture and the interactions with the editor 106. Generally, through the interface 104, the user is provided with an efficient, readable and user-friendly virtual representation of the system architecture provided by or communicated within the system. The term “graphical user interface,” or interface, can be used in the singular or the plural to describe one or more graphical user interfaces and each of the displays of a particular graphical user interface. Therefore, the interface 104 can represent any graphical user interface, including but not limited to, a web browser, touch screen, or command line interface (CLI) that processes information in architecture 100 and efficiently presents the system architecture to the user.

In general, the interface 104 can provide general interactive components that allow the client 102 to access and utilize various services and functions of the visualization environment. For example, the interface 104 can include a plurality of user interface (UI) components, some or all associated with the editor 106, such as interactive fields, pull-down lists, and buttons operable by the user at client 102. The interface 104 can also be configurable to support a combination of tables and graphs (e.g., bar, line, pie, status dials, etc.), and is able to build real-time portals, where tabs are delineated by key characteristics (e.g. site or micro-site). Therefore, the interface 104 includes any suitable graphical user interface, such as a combination of a generic web browser, intelligent engine, and CLI that processes information in the platform and visually presents the results to the user in a readable format. These and other UI components can be related to or represent the functions of the editor 106, as well as other software applications executing at the client 102 (e.g., the nester 108 and the virtual window 110). In particular, the interface 104 can be used to present a particular detailed level of the system architecture and to navigate the editor 106. For purposes of the present location, the interface 104 can be a part of or the entirety of the editor 106, while also merely a tool for displaying the visual representation of the client 102 interactions with the editor 106.

The illustrated client 102 can access an on-premise computing environment, including an interface 104. The interface 104 of the client 102 can comprise logic encoded in software and/or hardware in a suitable combination and operable to communicate with the network. More specifically, interface 104 can comprise software supporting one or more communication protocols such that the network or hardware is operable to communicate physical signals to and from the client 102. In some examples, the client 102 interacting with the interface 104 can generate a pan request to display an updated visual representation of a distinct portion of the system architecture relative to the current visual representation. In some examples, the client 102 interacting with the interface 104 can generate a resize request to display a selected component of the system architecture at a different size on an updated visual representation of the system architecture relative to the current visual representation.

In some implementations, the editor 106 facilitates the use of various editing features. In some implementations, the editor 106 can be a standard editor (e.g., Visio® or other editor). In some implementations, the editor 106 includes standard editing components, such as the possibility to add a component to the diagram of the system architecture. In some implementations, the editor 106 can change the size and properties of the diagram of the system architecture. The editor 106 can work as if the system architecture was only consisting of the content displayed by the interface 104, while the rest of the data included in the system architecture is persisted in a database.

The editor 106 in some aspects enables zoom-in and zoom-out functions. For example, at any time, the user can zoom-in to increase the visual detail of a component, which reduces the size of the virtual window 110. The zoom-in action can reveal possible agent components of the selected component. At any time, the user can zoom-out to decrease the visual detail of a component, which increases the size of the virtual window 110. The zoom-out action can reveal adjacent components which could not fit into the previous screen. In some examples, the zoom-out action can hide agent components of one or more components, which became smaller. In some implementations, a component can be resized at any point in time. Resizing a particular component can lead to a rendering action. In some examples, the rendering action can include hiding or showing one or more agent components of the component. In some examples, the rendering action can include merging or separating connections to adjacent components.

In some implementations, the nester 108 is an addition to standard diagram editors. The role of the nester 108 is to identify components included in other components. In some implementations, the nester 108 identifies agent components based on the relationship between components and agent components. In some implementations, the nester 108 allows a client 102 interacting with interface 104 to mark a component as ‘nested into’ another component. In some implementations, the definition between a component and one or more agent components can be automatically integrated in architecture 100. In some implementations, the definition between a component and one or more agent components can be integrated in architecture 100 by adding specific UI components (e.g., a contextual menu for the user to mark the relationship explicitly). In some implementations, the information including the correlation between a component and one or more agent components is stored in the shape data 112. In some implementations, the information including the correlation between a component and one or more agent components includes information about the coordinates, the geometry and the nesting level of each component (e.g., shape_{—}12345: upper left corner: −100, +250; lower right corner: −80, +210; shape: rectangle; nested_into: shape_{—}23456).

In some implementations, the virtual window 110 is an addition to standard diagram editors. The virtual window 110 is managed via UI components. In some examples, the virtual window 110 enables zoom-in and zoom-out functions by updating the data contained into the storage area of the screen data 116. In some examples, the virtual window component 110 enables the zoom-in and zoom-out functions by determining a plurality of coordinates for the virtual representation of a particular component of the system architecture at a particular level of detail and by specifying the new virtual coordinates of the screen corners with respect to the main diagram (e.g., upper left corner: −840, +525; lower right corner: +840, −525).

In some implementations, the renderer 114 generates a readable and meaningful virtual representation of the system architecture when the virtual window 110 encompasses a large number of components. In some implementations, the renderer 114 can mask components which would be too small to be readable. The masking function replaces the masked components with the nester component that contains such components. In some implementations, the renderer 114 can simplify the connections between components. For example, if a component reading from a data store and a component writing from the same data store become too small, the renderer can replace them with their nester component, shown as both reading to and writing from the data store.

In some implementations, the renderer 114 can perform multiple tasks. For example, a task of the renderer 114 is to intercept all communications between the editor 106 and the main database persisted into the storage area of shape data 112. The interception of communications enables the renderer 114 to translate back to the editor 106 is displayed next on the interface 104. In some implementations, the renderer 114 acts as an abstraction layer for the editor 106.

In some implementations, the information about the size of the system architecture is filtered by the renderer 114 and it is not transmitted to the editor 106. In some implementations, the renderer 114 informs the editor 106 of the data to display. For example, each time an action is to be committed into the database, the request generated by the editor 106 can be intercepted by the renderer 114, which can translate the coordinates of the system architecture and store the corresponding data in the screen data 116. For example, if the coordinates of the system architecture in the editor 106 are (0,0; +100, +100) and the coordinates of the system architecture in the virtual window 110 are (−100, −100; 0,0), the renderer 114 can perform the translation operation and store the newly added components with their adjusted coordinates into the storage area of the shape data 112.

In some implementations, the renderer 114 queries the shape data 112 each time a display refresh request is generated by the editor 106. Based on the response to the query, the renderer 114 retrieves the data stored in the virtual window 110. In some implementations, the renderer 114 can decide for each component, whether to keep it (e.g., if it is readable) or to hide it behind its corresponding nester component. The renderer 114 can re-compute the connections between different components. The resulting information can be sent from renderer 114 to the editor 106, which can render the information on the interface 104.

In some implementations, the renderer 114 intercepts the resize actions performed with the editor 106. For example, if a component of the visualized system architecture on interface 104 is stretched, the renderer 114 analyzes if and whether agent components exist and could be displayed. Based on deciding that agent components exist and should be displayed, the renderer 114 can also re-compute the connections between the agent components and other visualized components.

In some implementations, the renderer 114 communicates with the semantics module 118. In some implementations, the semantics module 118 can be a table, which is queried by renderer 114 to indicate the replacement rules for component s and connectors. In some examples, the semantics module 118 can indicate that the merge of multiple oval components is an oval component. In some examples, the semantics module 118 can indicate that the merge of different types of component shapes (e.g., oval or rectangle, possibly linked via connectors) including at least one agent component (e.g., a rectangle) is an agent component. In some examples, the semantics module 118 can indicate that the merge of different unidirectional connectors is a bidirectional connector.

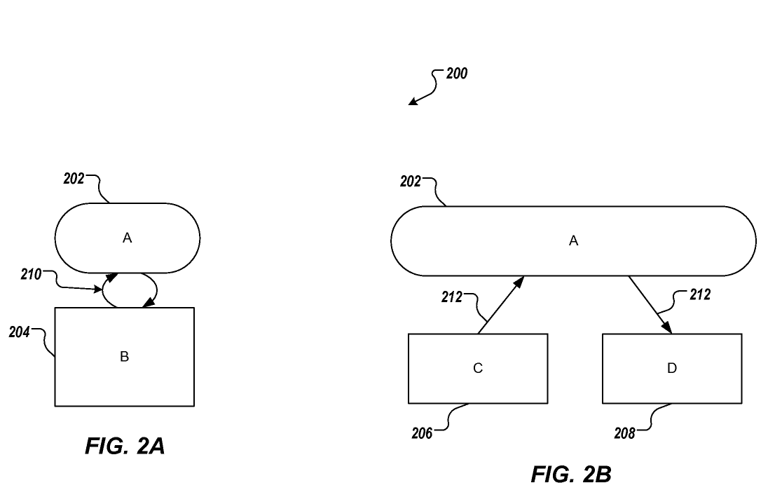

FIGS. 2A and 2B depict visual renderings of an example of system architecture 200 in accordance with implementations of the present disclosure. The example of system architecture 200 can be visualized on interface 104 and processed in the architecture 100, discussed with reference to FIG. 1. The example of system architecture 200 includes multiple components, such as component A 202, component B 204, component C 206, and component D 208, and connections between them. As illustrated in FIG. 2A, in some examples, a connection 210 between the components (e.g., component A 202 and component B 204) can be bidirectional. For example, if a component (e.g., component B 204) is a nester component, including 2 or more agent components (e.g., component C 206 and component D 208), which are hidden from visualization, the connection 210 appears as bidirectional. In some implementations, the bidirectional connection 210 between components can define multiple functions (e.g., read and write functions) and/or security types (e.g., HTTPS, SNC, and HTTP). As illustrated in FIG. 2B, in some examples, a connection 212 between the components (e.g., component A 202 and component C 206) can be unidirectional. In some implementations, a unidirectional connection 212 between components can define a single function (e.g., a read or write function).

As illustrated, for instance, a change of view (e.g., a zoom in) from the view of architecture 200 from FIG. 2A to FIG. 2B may reveal that component B 204 includes agent components C 206 and D 208. This change of view may also reveal that connection 210, which is a multi-function (e.g., multi-directional) connector includes two separate connectors 212 (e.g., two separate functions that communicably couple components C 206 and D 208 to component A 202). The semantic relevance of the connection may remain, however, with the change of view to connectors 212. In some aspects, connectors (e.g., 210, 212, or other connections) may be semantically relevant because the connections define a relationship (e.g., match, association, or other relationship) between metadata (or other attributes) of the connected components.

In some implementations, semantic relevance is defined as metadata information conveyed by the shape, annotations and connections between diagram elements. For example, arrow connectors can express data-related operations, such as a read operation, a write operation or a read and write operation. A read operation can be indicated by a storage-to-agent connector. A write operation can be indicated by an agent-to-storage connector. A read-and-write operation can be indicated by a double-arrow between storage and agent components. As illustrated in FIGS. 2A and 2B, the replacement of super-component B 204 with the corresponding components C 206 and D 208 requires the modification of the connectors according to the semantic perspective (e.g., connector 210 corresponding to the SUM of both operations is replaced by connectors 212).

In some implementations, a client (e.g., client 102 in FIG. 1) interacting with an interface (e.g., interface 104 in FIG. 1) can request a different visualization of the system architecture. In some examples, the user can generate a zoom-in request for the component B 204, which leads to the initiation of a renderer action, as explained with reference to FIG. 1. The renderer can modify the visualization of the system architecture making agent components C 206 and D 208 visible, resizing component A 202 and correspondingly modifying the connections between components from bidirectional to unidirectional, as illustrated in FIG. 2B. Similarly, a user can zoom-out, making the agent components C 206 and D 208 disappear from the display if the renderer identifies that their size is below the readable threshold.

In some implementations, rendering a particular component is associated with an update of the component's coordinates, which can be different from the initial visual representation. In some implementations, prior to rendering a particular component (e.g., component B 204) at the second plurality of coordinates (e.g., as illustrated in FIG. 2B), it is determined whether the particular component comprises at least two agent components (e.g., agent components C 206 and D 208) within the particular component. In some implementations, rendering further includes determining that a size of each of the agent components (e.g., agent components C 206 and D 208) meets the threshold size to be viewed in the second visual representation. For example, if the agent components (e.g., agent components C 206 and D 208) are above the threshold size for viewing, they become visible in the second visual representation (e.g., as illustrated in FIG. 2B).

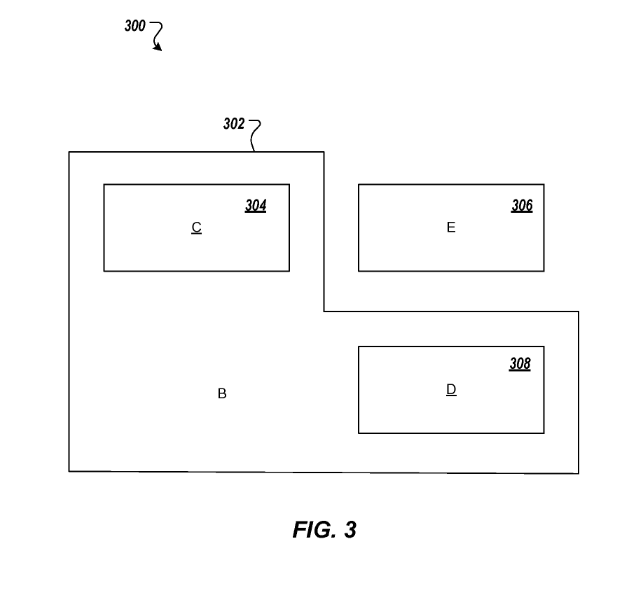

FIG. 3 depicts visual renderings of an example of system architecture 300 in accordance with implementations of the present disclosure. The example of system architecture 300 can be visualized on interface 104 and processed in the architecture 100, as discussed with reference to FIG. 1. The example of system architecture 300 includes multiple components, such as component B 302, component C 304, component D 308 and component E 306. As illustrated in FIG. 3, in some examples, the virtual display of the system architecture can include a nester component B 302. The nester component B 302 includes multiple agent components (e.g., component C 304, component D 308), their inclusion being marked by a particular indicator (e.g., a line around the agent components, a color code, a contrast code, etc.).

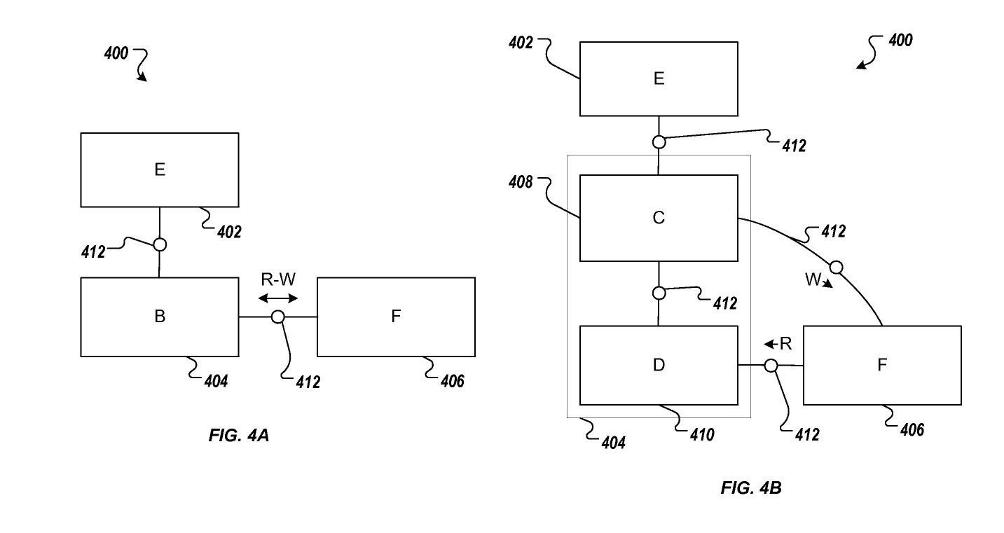

FIGS. 4A and 4B depict examples of system architecture 400 in accordance with implementations of the present disclosure. The example of system architecture 400 can be visualized and processed in the architecture 100 discussed with reference to FIG. 1. The example of system architecture 400 includes multiple components, such as component E 402, component B 404, component F 406, component C 408 and component D 410 and connections between the components.

As illustrated in FIG. 4A, in some examples, a nester component B 404 can have a single connection (e.g., with component E 402) and a composite connection (e.g., with component F 406). In some implementations, composite connections can be displayed different from single connections (e.g., with a line width increasing with the number of included connections). To maintain the semantics, composite connections including different unidirectional connections (e.g., read and write) can be displayed as bidirectional connections (e.g. as both read and write). As illustrated in FIG. 4B, the system architecture 400 can be displayed such that the agent components C 408 and D 410 of the nester component B 404 are visible, illustrating that the component E 402 is singularly connected to agent component C 408 and component F is singularly connected to each of the agent components C 408 and D 410. In some implementations, a rendering can include determining and updating at least one semantically relevant connector 412 that extends between the agent components at an updated level of detail. The semantically relevant connectors 412 define functional interactions between the agent components and other components. For example, a zoom-in action can reveal the agent components C 408 and D 410 of component B 404 and lead to a substitution of the bidirectional connection 412 between component B 404 and component F 406 (illustrated in FIG. 4A) with two or more unidirectional connections (e.g., illustrated in FIG. 4B). In some implementations, a zoom-in action can lead to substitution of the bidirectional connection 412 (e.g., illustrated in FIG. 4A) with one or more unidirectional connection and one or bidirectional more connections 412 (e.g., illustrated in FIG. 4A).

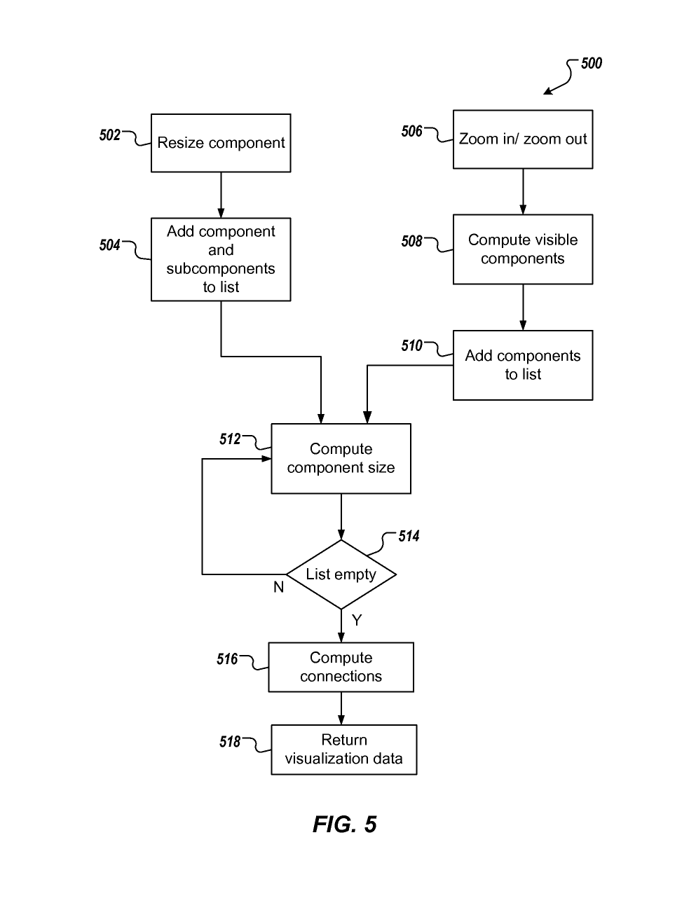

FIG. 5 illustrates a flowchart depicting an example method 500 that can be executed in accordance with implementations of the present disclosure. The method 500 can be implemented in the systems 100, 200, 300, and 400 discussed with reference to FIGS. 1-4, respectively. In some implementations, the resize process can be executed using the steps of method 500. In some implementations, the zoom-in and zoom-out process can be executed using the steps of method 500. The method 500 may allow a client to use standard editing protocols for various system architectures.

An on-demand computing environment, in particular the renderer, receives a request from a user in an on-premise computing environment to perform a resize process on the visualized system architecture (502). For example, the user may request to resize a single component. A communication to the on-demand computing environment is initiated (504). In some implementations, the communication includes the request to add a component and agent components to the list of visualized components (e.g., the resized component).

In some implementations, the method 500 can be initiated by receiving a request to perform a zoom-in or a zoom-out process on the visualized system architecture including a particular number of displayed components (506). In some implementations, the request is received at an on-demand computing environment (e.g., the virtual window 110) from a user in an on-premise computing environment. The on-premise computing environment computes an updated list of visible components (508). In some implementations, the visible components in the updated list are identified based on the request received from the client and a threshold size to be viewed in the second visual representation. In some implementations, the visible components in the updated list are identified based on the request received from the client and the data stored in the screen data. The on-premise computing environment compares the displayed components with the updated list of components to identify the components to be added or removed from the displayed components (510). For example, the added components can correspond to the list of visible components “on-screen” (e.g. components, which are visible to the user because their coordinates are within the ones of the virtual window). The added components can also correspond to the components nested by the visible components “on-screen.”

The on-demand computing environment can compute the component size (512). In some implementations, the computation includes determining a first plurality of coordinates for the virtual representation of the component of the system architecture visualized at a first level of detail. The first plurality of coordinates defines a location of the determined virtual representation in the first visual representation. The first plurality of coordinates can be persisted in a database. Based on the received request, the computation further includes determining a second plurality of coordinates different from the first plurality of coordinates for the virtual representation of the particular component of the system architecture at the second level of detail. In some implementations, determining a second plurality of coordinates includes retrieving, based on the received request, the persisted first plurality of coordinates to determine the second plurality of coordinates. The second plurality of coordinates defines a location of the determined virtual representation in the second visual representation.

In some implementations, the computation uses the list of additional components previously provided. It can be determined whether the list is empty (e.g., whether additional components were requested by the client through the initiated process) (514). If the list is not empty, then the size of the remaining components is computed (512). If the list is empty, the connections between the listed components are computed (516).

The visualization of the system architecture is updated, including the listed components and the computed connections (518). In some implementations, once the visualization data is returned, the visualization data can be presented to the user by generating a second visual representation of the system architecture for display on a graphical user interface. The updated visual representation of the system architecture can include respective virtual representations of the system architecture components at a level of detail different than the initial level of detail. In some examples, the updated level of detail can have a finer granularity relative to the initial level of detail in case the process 500 was initiated with a zoom-in action. In some examples, the updated level of detail can have a coarser granularity relative to the initial level of detail in case the process 500 was initiated with a zoom-out action. The updated virtual representation can include a semantically relevant connector that extends between the two components of the system architecture at the updated level of detail. In some implementations, the method 500 can be a part of an editing application. In some implementations, the method 500 can be delivered as a standalone tool, which can be called by a system architecture visualization tool.

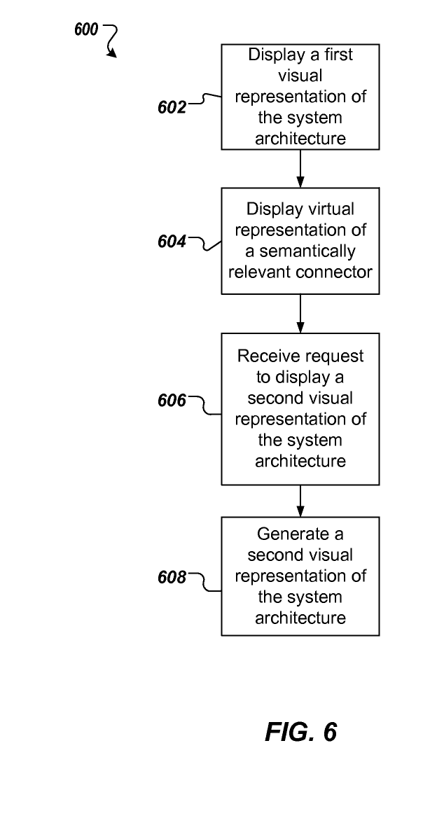

FIG. 6 illustrates a flowchart depicting an example method 600 that can be executed in accordance with implementations of the present disclosure. The method 600 can be implemented in the systems 100, 200, 300, and 400 discussed with reference to FIGS. 1-4, respectively. In some implementations, the update of the system architecture visualization can be executed using the steps of method 600. The method 600 allows the update of the system architecture visualization based on the request to display an updated visual representation of the system architecture.

An interface displays a first visual representation of the system architecture (602). The first visual representation includes respective virtual representations of two or more components of the system architecture at a first level of detail.

The interface displays a first virtual representation of a semantically relevant connector that extends between the components of the system architecture at the first level of detail (604). The semantically relevant connector defines a functional interaction between the components of the system architecture. In some implementation, the virtual representations of the semantically relevant connector represent two or more functions that define the functional interaction between the components of the system architecture. In some implementation, the virtual representation includes unique symbols representing the functions. For example, the functions can include a read function and a write function. One of the unique symbols can represent the read function and another of the unique symbols can represent the write function, and a single symbol can represent a read/write function.

An on-demand computing environment receives a request from a client to display a second visual representation of the system architecture (606). The computing environment generates a second visual representation of the system architecture for display on a graphical user interface (608). The second visual representation of the system architecture includes respective virtual representations of the components of the system architecture at a second level of detail. The second level of detail is different to the first level of detail. The second virtual representation of the semantically relevant connector extends between the components of the system architecture at the second level of detail.

In some implementation, the method 600 can further include determining that some of the components in the first visual representation of the system architecture are agent components of the components in the second visual representation of the system architecture. In some implementation, the method 600 can further include determining that some of the components in the second visual representation of the system architecture are agent components of the components in the first visual representation of the system architecture. In some implementation, the method 600 can further include the generation of a visual representation of the other components that encompasses the portion of the agent components. In some implementations, the method 600 can be a part of a system architecture visualization tool. In some implementations, the method 600 can be delivered as a standalone tool, which can be called by a computing system.

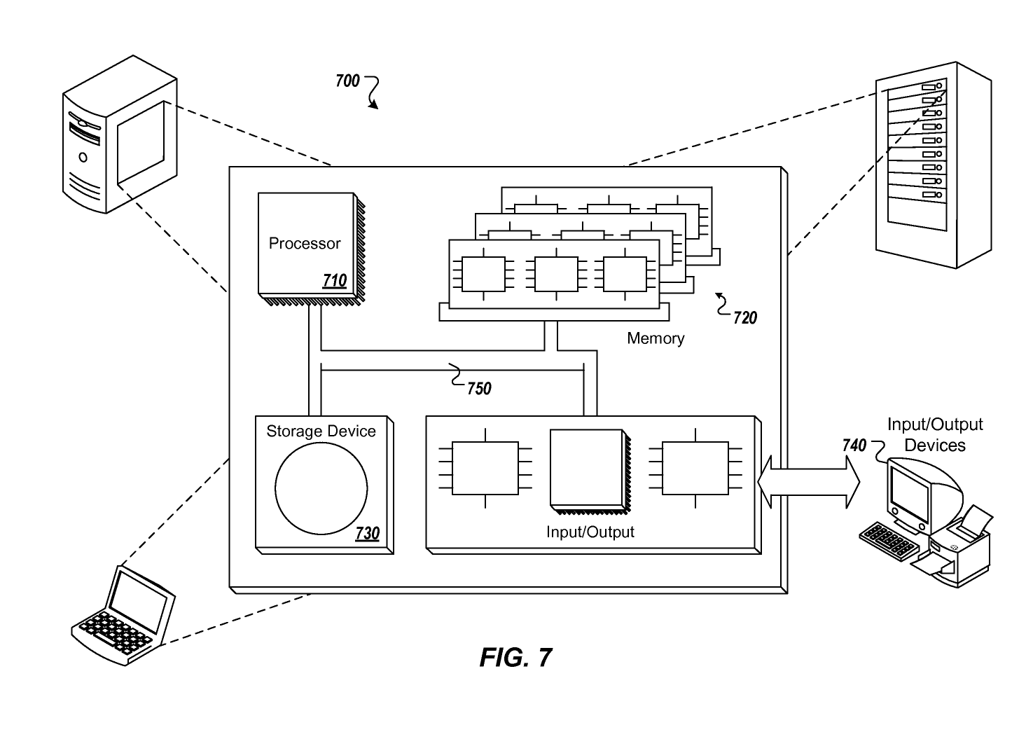

Referring now to FIG. 7, a schematic diagram of an example computing system 700 is provided. The system 700 can be used for the operations described in association with the implementations described herein. For example, the system 700 can be included in any or all of the server components discussed herein. The system 700 includes a processor 710, a memory 720, a storage device 730, and an input/output device 740. The components 710, 720, 730, 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit. The storage device 730 is capable of providing mass storage for the system 700. In one implementation, the storage device 730 is a computer-readable medium. In various different implementations, the storage device 730 can be a floppy disk device, a hard disk device, an optical disk device, or a tape device. The input/output device 740 provides input/output operations for the system 700. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor can receive instructions and data from a read-only memory or a random access memory or both. Components of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps can be provided, or steps can be eliminated, from the described flows, and other components can be added to, or removed from, the described systems.

A number of implementations of the present disclosure have been described. Nevertheless, it can be understood that various modifications can be made without departing from the spirit and scope of the present disclosure. Accordingly, other implementations are within the scope of the following claims.

What is claimed is:

1. A computer-implemented method performed by one or more processors for managing a display of a system architecture, the method comprising:
displaying a first visual representation of the system architecture, the first visual representation comprising respective virtual representations of at least two components of the system architecture at a first level of detail;
displaying a first virtual representation of a semantically relevant connector that extends between the at least two components of the system architecture at the first level of detail, the semantically relevant connector defining a functional interaction between the at least two components of the system architecture;
receiving a request from a user to display a second visual representation of the system architecture; and
generating a second visual representation of the system architecture for display on a graphical user interface, the second visual representation of the system architecture comprising respective virtual representations of the at least two components of the system architecture at a second level of detail different than the first level of detail, and a second virtual representation of the semantically relevant connector that extends between the at least two components of the system architecture at the second level of detail.

2. The method of claim 1, further comprising:
changing from the first virtual representation of the semantically relevant connector to the second virtual representation of the semantically relevant connector based on the request to display the second visual representation of the system architecture.

3. The method of claim 2, wherein the first and the second virtual representations of the semantically relevant connector represent at least two functions that define the functional interaction between the at least two components of the system architecture.

4. The method of claim 3, wherein the first virtual representation comprises unique symbols representing the at least two functions, and the second virtual representation comprises a single symbol representing the at least two functions.

5. The method of claim 4, wherein the at least two functions comprise a read function and a write function, and one of the unique symbols represents the read function and another of the unique symbols represents the write function, and the single symbol represents a read/write function.

6. The method of claim 3, wherein the second virtual representation comprises unique symbols representing the at least two functions, and the first virtual representation comprises a single symbol representing the at least two functions.

7. The method of claim 1, further comprising:
determining that two of the at least two components are agents of another of the at least two components; and
based on the request from the user to display the second visual representation of the system architecture, generating a visual representation of the other of the at least two components that encompasses at least a portion of the two of the at least two components.

8. The method of claim 1, wherein receiving a request from a user to display a second visual representation of the system architecture comprises at least one of:
receiving a zoom-in request from the user to display the second visual representation of the system architecture at a finer granularity relative to the first visual representation; or
receiving a zoom-out request from the user to display the second visual representation of the system architecture at a coarser granularity relative to the first visual representation.

9. The method of claim 1, wherein receiving a request from a user to display a second visual representation of the system architecture comprises:
receiving a pan request from the user to display the second visual representation of a distinct portion of the system architecture relative to the first visual representation.

10. The method of claim 1, wherein receiving a request from a user to display a second visual representation of the system architecture comprises:
receiving a resize request from the user to display a selected component of the system architecture at a different size in the second visual representation relative to the first visual representation.

11. The method of claim 1, further comprising:
determining a first plurality of coordinates for a virtual representation of a particular component of the at least two components of the system architecture at the first level of detail, the plurality of coordinates defining a location of the determined virtual representation in the first visual representation.

12. The method of claim 11, further comprising:
based on the received request, determining a second plurality of coordinates different than the first plurality of coordinates for the virtual representation of the particular component of the at least two components of the system architecture at the second level of detail, the second plurality of coordinates defining a location of the determined virtual representation in the second visual representation.

13. The method of claim 12, further comprising:
persisting the determined first plurality of coordinates in a database; and
retrieving, based on the received request, the persisted first plurality of coordinates to determine the second plurality of coordinates.

14. The method of claim 13, wherein the request comprises a resize request, the method further comprising:
determining, based on the request, that the second plurality of coordinates defines a size of the particular component that meets a threshold size to be viewed in the second visual representation; and
rendering the particular component at the second plurality of coordinates for viewing in the second visual representation.

15. The method of claim 14, further comprising:
prior to rendering the particular component at the second plurality of coordinates, determining that the particular component comprises at least two agent components within the particular component;
determining that a size of each of the agent components meets the threshold size to be viewed in the second visual representation; and
rendering the agent components for viewing in the second visual representation within the particular component.

16. The method of claim 15, further comprising:
determining at least one semantically relevant connector that extends between the agent components at the second level of detail, the semantically relevant connectors defining functional interactions between the agent components.

17. The method of claim 16, further comprising:
rendering the at least one semantically relevant connector that extends between the agent components in the second visual representation.

18. The method of claim 11, wherein the first plurality of coordinates comprise Cartesian coordinates.

19. A computer program product tangibly embodied on a non-transient computer readable medium for managing a display of a system architecture, the computer program product storing instructions operable when executed by a hardware processor to perform operations comprising:
displaying a first visual representation of the system architecture, the first visual representation comprising respective virtual representations of at least two components of the system architecture at a first level of detail;
displaying a first virtual representation of a semantically relevant connector that extends between the at least two components of the system architecture at the first level of detail, the semantically relevant connector defining a functional interaction between the at least two components of the system architecture;
receiving a request from a user to display a second visual representation of the system architecture; and
generating a second visual representation of the system architecture for display on a graphical user interface, the second visual representation of the system architecture comprising respective virtual representations of the at least two components of the system architecture at a second level of detail different than the first level of detail, and a second virtual representation of the semantically relevant connector that extends between the at least two components of the system architecture at the second level of detail.

20. A system of one or more computers configured to perform operations comprising:
displaying a first visual representation of the system architecture, the first visual representation comprising respective virtual representations of at least two components of the system architecture at a first level of detail;
displaying a first virtual representation of a semantically relevant connector that extends between the at least two components of the system architecture at the first level of detail, the semantically relevant connector defining a functional interaction between the at least two components of the system architecture;
receiving a request from a user to display a second visual representation of the system architecture; and
generating a second visual representation of the system architecture for display on a graphical user interface, the second visual representation of the system architecture comprising respective virtual representations of the at least two components of the system architecture at a second level of detail different than the first level of detail, and a second virtual representation of the semantically relevant connector that extends between the at least two components of the system architecture at the second level of detail.
